(19) United States
(12) Patent Application Publication
(10) Pub. No.: US 2023/0169452 A1
(43) Pub. Date: Jun. 1, 2023

(54) System Configuration for Learning and Recognizing Packaging Associated with a Product

(71) Applicant: ZEBRA TECHNOLOGIES CORPORATION, Lincolnshire, IL (US)

(72) Inventors: Alessandro Bay, London (GB); Andrea Mirabile, London (GB); Stuart Peter Hubbard, Loughborough (GB); Ankit Kumar, Essex (GB); Samadhi Poornima Kumarasinghe Wickrama Arachchilage, London (GB); Eunhyang Kim, London (GB); Matthew B. Hayes, Wheaton, IL (US); Michele Taroni, London (GB)

(21) Appl. No.: 17/538,183

(22) Filed: Nov. 30, 2021

(51) Int. Cl. G06Q 10/08; G06K 7/14; G06K 7/10; G06N 20/00

(52) U.S. Cl. CPC G06Q 10/087; G06K 7/1413; G06K 7/1447; G06K 7/10861; G06N 20/00

(57) ABSTRACT

In some implementations, a system may receive, from a barcode reader, read data associated with the barcode reader reading a barcode associated with a product. The system may receive, from an imager, image data associated with an image that depicts packaging of the product. The system may decode the read data to obtain product information that is associated with the product. The system may generate a product entry that associates the product information with the image data. The system may perform an action associated with the product entry to enable an image processing model to identify the product information based on the packaging depicted in the image.

### BACKGROUND

Certain entities may seek to monitor and/or detect items that are managed or associated with the entity. For example, an entity may seek to monitor and/or determine information (e.g., remaining quantity in a particular location such as a store front) associated with products in an inventory and/or that are for sale. In such a case, the entity, such as a retail organization or other type of enterprise, may obtain and/or process images of the products from an imager (e.g., a security camera, a camera of a user device of an employee, a camera of a robotic device processing or handling the products, and/or other type of camera) to monitor the products and/or determine the information associated with the product. Accordingly, there is a need for a system and/or model that is capable of identifying and/or recognizing products depicted in images and/or processing information associated with the products.

### SUMMARY

Some implementations described herein relate to a method for enabling recognition of product packaging. The method may include receiving, by a device and from a barcode reader, read data associated with the barcode reader reading a barcode associated with a product. The method may include receiving, by the device and from an imager, image data associated with an image that depicts packaging of the product. The method may include decoding, by the device, the read data to obtain product information that is associated with the product. The method may include generating, by the device, a product entry that associates the product information with the image data. The method may include performing, by the device, an action associated with the product entry to enable an image processing model to identify the product information based on the packaging depicted in the image.

Some implementations described herein relate to a tangible machine-readable medium that stores a set of instructions for a device. The set of instructions, when executed by one or more processors of the device, may cause the device to receive, from a barcode reader, read data associated with the barcode reader reading a barcode associated with a product. The set of instructions, when executed by one or more processors of the device, may cause the device to receive, from an imager, image data associated with an image that depicts packaging of the product. The set of instructions, when executed by one or more processors of the device, may cause the device to decode the read data to obtain product information that is associated with the product. The set of instructions, when executed by one or more processors of the device, may cause the device to generate a product entry that associates the product information with the image data. The set of instructions, when executed by one or more processors of the device, may cause the device to perform an action associated with the product entry to enable an image processing model to identify the product information based on the packaging depicted in the image.

Some implementations described herein relate to a product processing station. The product processing station may include a barcode reader and an imager. The product processing station may be configured to receive, from the barcode reader, read data associated with a barcode that is associated with a product. The product processing station may be configured to decode the read data to obtain product information that is associated with the product. The product processing station may be configured to cause, based on receiving the read data from the barcode reader, the imager to capture an image that depicts packaging of the product. The product processing station may be configured to generate an entry that associates the product information with image data associated with the image. The product processing station may be configured to perform an action associated with the entry to enable an image processing model to identify the product information based on the packaging depicted in the image.

### BRIEF DESCRIPTION OF THE DRAWINGS

FIG. 1 is a diagram of an example implementation associated with a product processing station for learning and recognizing packaging associated with a product as described herein.

FIG. 2 is a diagram of an example implementation associated with a product management system described herein.

FIG. 3 is a diagram of another example implementation associated with a product management system described herein.

FIG. 4 is a diagram of an example environment in which systems and/or methods described herein may be implemented.

FIG. 5 is a diagram of example components of one or more devices of FIG. 4.

FIG. 6 is a flowchart of an example processes associated with a system configuration for learning and recognizing packaging associated with a product.

### DETAILED DESCRIPTION

The following detailed description of example implementations refers to the accompanying drawings. The same reference numbers in different drawings may identify the same or similar elements.

An image processing model may be configured to recognize various objects according to various techniques. For example, a system may include an image processing model that is configured to recognize an object (e.g., products, inventory, samples, supplies, consumables, and/or the like) based on a reference database of images that depict the object and/or are used to train the image processing model. Accordingly, in order to identify a particular type of object (e.g., a particular product), a system may be configured to recognize the product as depicted in reference images according to an appearance of packaging (e.g., based on package features, such as type, size, color, shape, or other physical characteristics) associated with the product. Typically, the reference images need to be collected from various angles and/or in association with dedicated processes for training the image processing model.

Furthermore, appearances of packaging for products (and/or appearances of products within packaging) may vary and/or change overtime due to multiple factors. For example, a design of the packaging may change (e.g., based on variation in packages features), a design of the product may change, alterations to the packaging or items (e.g., caused by markings being added or additional labels for tracking or shipping), damage to packaging (e.g., dents, scratches, or other types of anomalies), and so on. Accordingly, there is a need for a product management system and/or a model that is can robustly and accurately detect, learn, and/or recognize packaging (e.g., new packaging) associated with a product without requiring a dedicated system for individually training the system or the model to recognize the packaging associated with the product.

Some implementations described herein provide a product management system for detecting, learning, and/or recognizing packaging associated with a product that is depicted in images that are captured in association with a barcode reader or other type of reader device. For example, as described herein, a product processing station may be configured to include a barcode reader and an imager that captures an image of a product in association with a barcode of the product being read by the barcode reader. The product processing station may indicate that the image is associated with the product based on product information that is obtained based on a decoding of the barcode. Accordingly, over multiple iterations for various products, the product processing station may generate multiple corresponding product entries for the various products that can be used to train a product recognition model. The product recognition model may include an image processing model that is trained and/or configured to identify a product according to packaging of the product, as described herein. Moreover, because the product processing station may be operated in association with various other activities (e.g., facilitating a transaction involving a product, facilitating routing of a product in association with shipping the product, or other activities associated with use of a barcode read of a product), reference images of the product can be passively captured without requiring a separate process or a user manually capturing the reference images.

In this way, the product processing station (and/or product management system), as described herein, enables a packaging of a product to be dynamically recognized and/or learned. Accordingly, relative to other systems that do not utilize the product processing station, as described herein, the product management system may prevent consumption of resources for collecting images of a product (e.g., because a dedicated system or process may not need to be configured to collect the images) and mapping the images of the product for recognition. Furthermore, the product processing station may permit the product management system to dynamically learn or identify new packaging associated with products, learn or identify new products (e.g., because the product processing station may automatically identify or detect packaging that previously was not associated with a product), and/or learn or identify new product information (e.g., identification information obtained by a reader or read operation) that is associated with products.

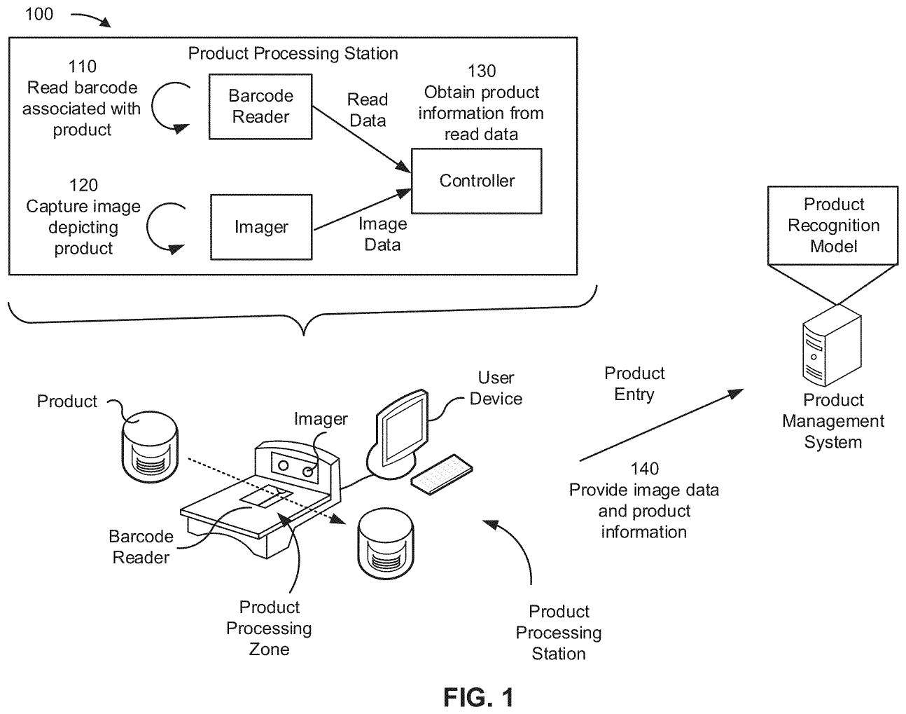

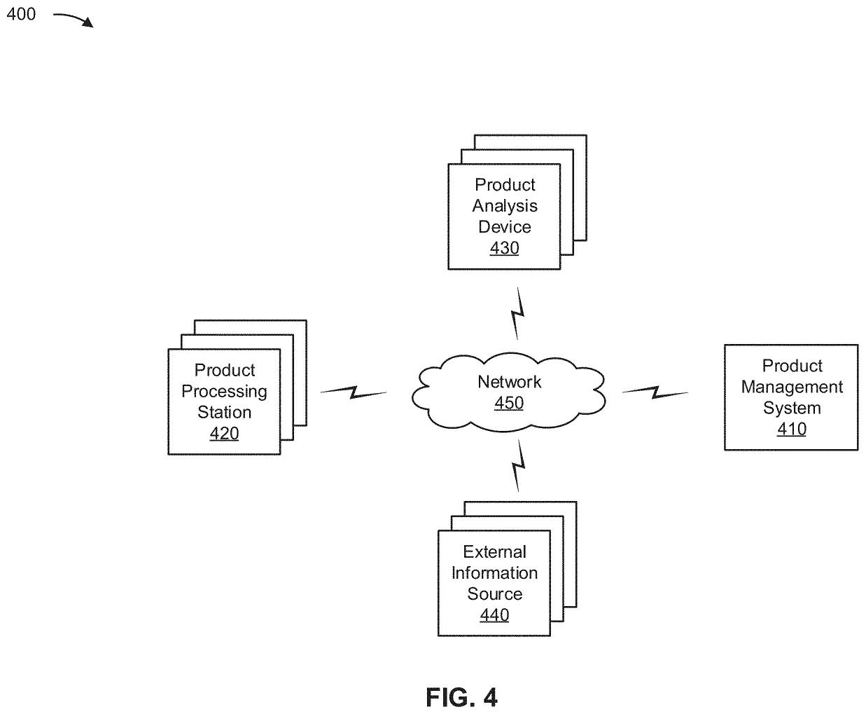

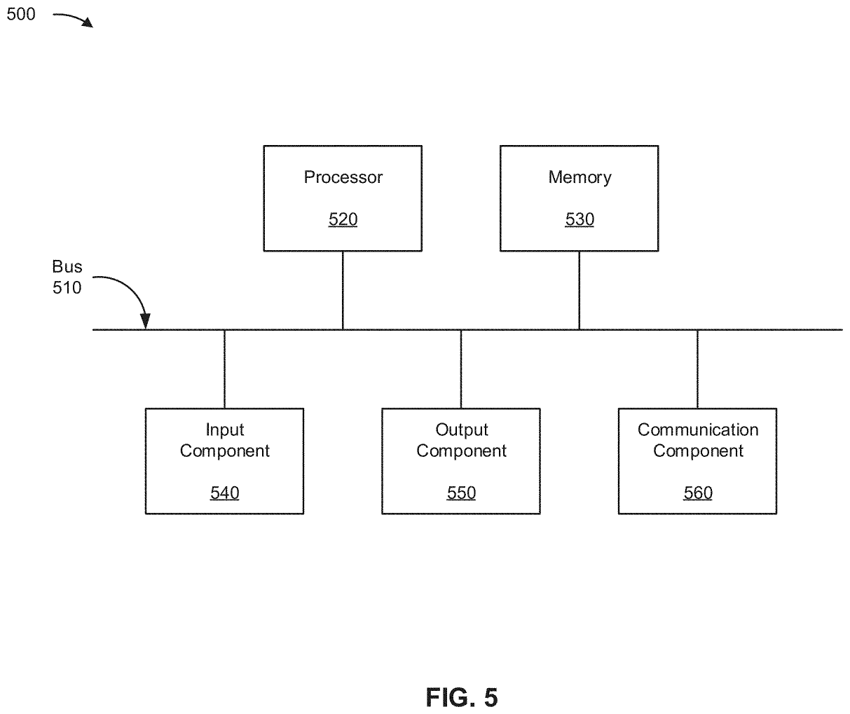

FIG. 1 is a diagram of an example implementation 100 associated with a product processing station for learning and recognizing packaging associated with a product, as described herein. As shown in FIG. 1, example implementation 100 includes a product processing station and a product management system. These devices are described in more detail below in connection with FIG. 4 and FIG. 5.

In example implementation 100, the product processing station includes a barcode reader and an image (e.g., a camera or other type of imaging device). The barcode reader may include a manually controlled device that is configured to be held by and/or attached to a user and triggered (e.g., using a button or other input device) by the user to scan barcodes. Additionally, or alternatively, the barcode reader may include an automatically controlled device that can continuously monitor a physical environment of the barcode reader, detect when a barcode is placed within a field of view of the barcode scanner, and automatically scan the detected barcodes. While certain examples are described herein in connection with a barcode reader analyzing a barcode associated with a product, such examples may similarly apply to utilizing a radio frequency identification (RFID) reader that is configured to read an RFID tag associated with the product. For example, the product processing station may include a RFID reader that is configured to identify and/or obtain product information associated with a product based on an RFID tag that is attached to the product and/or packaging of the product.

The imager may include any suitable imager that is capable of capturing an image of packaging of a product, as described herein. The imager may be configured to capture the image based on receiving an instruction from the product processing station, the barcode reader, a user, and/or any suitable device. The product management system includes a product recognition model described herein. In some implementations, the product processing station may include the product recognition model and/or may train or utilize the product recognition model, as described elsewhere herein.

As shown in FIG. 1, and by reference number 110, the product processing station reads a barcode associated with a product. For example, a controller of the product processing station may receive, from the barcode reader, read data. The read data may be associated with (and/or generated from) the barcode reader reading a barcode associated with the product. For example, the barcode reader can be used to decode a barcode that is attached to the product to permit a system (e.g., the product processing station and/or the product management system) to obtain product information associated with the product. The product information may include a product identifier (e.g., a stock keeping unit (SKU) number, a universal product code, or other type of unique identifier associated with the system).

The product processing station and/or the barcode reader may read the barcode based on detecting the barcode within a product processing zone of the product processing station. For example, the product processing zone may be within a field of view of the barcode reader, and the barcode reader may be configured to automatically perform a read operation of a barcode that is within the product processing zone. In this way, when the product is moved into or through the product processing zone (e.g., in association with a user, such as a clerk, processing the product in association with a purchase of the product), the barcode reader may read a barcode on the product.

In this way, the product processing station, via the barcode reader, may read the barcode associated with the product and/or obtain product information associated with the barcode.

As further shown in FIG. 1, and by reference number 120, the product processing station captures an image depicting the product. The imager may capture the image in association with the barcode reader reading the barcode. For example, the product processing station may cause the imager to capture the image of the product (and/or the packaging of the product) based on detecting that the barcode reader performed a read of the barcode.

The product processing zone may correspond to and/or be within an overlapping portion of a field of view of the barcode reader and a field of view of the imager. For example, accordingly, based on the barcode reader reading the barcode of the product while the product is within the field of view of the barcode reader, the product processing station may cause the imager to capture an image of the product (e.g., because the product is presumed to still be within the product processing zone). Accordingly, the product processing zone may be within the field of view of the barcode reader and the field of view of the imager. In some implementations, the field of view of the imager may be adjacent a field of view of the barcode reader (e.g., in a downstream location of the product processing station). For example, for a product processing station that includes a product receiving mechanism (e.g., a conveyer or other receiving surface) that is adjacent a barcode reader that facilitates handoff of a product from a clerk to a customer, the imager may have a field of view that includes the product receiving mechanism in order to permit the imager to capture an image of the product after the product is removed from a field of view of the barcode reader (e.g., because the clerk moved the product through the product processing zone too quickly).

In this way, the product processing station may capture the image of the product and/or cause the imager to capture the image of the product in association with the barcode reading a barcode associated with the product.

As further shown in FIG. 1, and by reference number 130, the product processing station obtains product information from the read data. For example, the product processing station may obtain the product information based on decoding the read data that is generated and/or received from a read of the barcode. The product processing station may decode the read data using any suitable technique.

The product information may include any information associated with a product and/or that can be obtained in association with a read of the barcode associated with the product. For example, the product information may include information that identifies the product identifier associated with the product, a name of the product, a description of the product, a characteristic of the product (e.g., version and/or size), or other product information.

In some implementations (e.g., in addition to or as an alternative to processing the read data), the product information may be obtained and/or received via a manual operation performed by an operator of the product processing station. For example, the product information may be obtained based on a user of the product processing station (e.g., an individual purchasing the product using a self-service product processing station and/or a clerk operating the product processing station) performing a manual product (or price) look up (PLU) (e.g., a search of a product database associated with the product processing station) via a user interface of the product processing station (e.g., because the reader cannot read the barcode, because the product did not receive a barcode, and/or a barcode became detached from the product, among other examples). In this way, based on the manual PLU, the product processing station may obtain product information that is associated with the product.

As further shown in FIG. 1, and by reference number 140, the product processing station provides a product entry to the product management system. The product processing station may generate the product entry to include the product information and/or image data associated with the image. In this way, the product processing station may associate the image data with the product by appending the product information to the image data (or vice versa).

The image data may include the image that was captured by the imager and/or a pre-processed image. For example, the product processing station may process the image to identify a portion of the image that includes packaging of the product (e.g., using a bounding box technique). In this way, the image data may only include a portion of the image that depicts the packaging of the product.

In some implementations, the product entry may include information associated with a location of the product (which may correspond to a location of the product processing station). For example, the product processing station may include, within the product information, information associated with the product processing station in order to permit the product management system to identify and/or determine a location of the product (or where a barcode of the product was read or where an image of the product was captured). Accordingly, the product processing station may indicate a location of the product processing station within the product entry. Additionally, or alternatively, the product processing station may include information associated with the barcode reader and/or the imager. For example, the product processing station may include configuration information associated with a configuration of the barcode reader and the imager. More specifically, the product processing station may indicate whether a field of view of the imager corresponds to a same field of view of the barcode reader (e.g., to determine whether images captured by the imager include or should include a certain part of the packaging).

As described herein, the product processing station may transmit the product entry to the product management system. In this way, the product management system may train and/or update the image processing model based on the product entry (e.g., to more accurately recognize the product based on the image data in the product entry). Additionally, or alternatively, the product management system may store the product entry in a reference data structure. The reference data structure may be associated with the product processing station and/or the product management system. In some implementations, reference data in the reference data structure may be used to train the image processing model. For example, the reference data may include product entries associated with products that were previously processed using the product processing station and/or another product processing station configured in a similar manner as the product processing station.

In some implementations, the product processing station (and/or product management system) may train an image processing model associated with the product recognition model. For example, the image processing model may be a local model that is stored and/or managed by the product processing station (e.g., via the controller). In such a case, the product processing station may train the image processing model to identify the product based on the packaging and/or an identifier obtained in association with a read operation (and/or a manual operation, such as a manual price lookup performed by an operator of the product processing station).

In some implementations, as described herein, the product processing station may utilize the trained image processing model to identify a product (e.g., without using a reader to identify the product via a read operation). For example, in some cases, a product that is to be processed via the product processing station may not include a barcode that enables the product processing station to identify the product (e.g., fresh produce or other unmarked retail items stored together in a bin, retail items that didn't receive or that lost an associated barcode, or the like). Based on determining that previously captured images of the product were obtained in association with a read operation (or product/price look up), the product processing station may automatically identify the product and/or process the product (e.g., assign a product identifier or a price to the product), accordingly.

Furthermore, the product processing station may utilize the trained (and/or updated) image processing model to verify that individual barcodes that are attached to products are associated with the products. For example, when a barcode is read, the product processing station may use the image processing model to verify that the packaging of the product depicted in the image matches the product information obtained from the read of the barcode. In this way, the product processing station may confirm that a product was accurately read (e.g., in the event a barcode was misplaced onto a wrong product).

In some implementations, the product processing station (and/or the product management system) may retrain the image processing model by updating the reference data to include validated or invalidated results associated with whether the image processing model accurately or inaccurately detected, learned, and/or recognized that packaging was associated with a particular product, as described herein (e.g., based on a user input and/or feedback from the user).

The product processing station may include a transaction terminal that is capable of facilitating an electronic transaction involving one or more products. For example, the electronic transaction may involve a purchase of products from a retail organization. Accordingly, the product processing station may collect and/or provide product analysis entries associated with the products, as described herein, in association with facilitating electronic transactions involving the products. In this way, the product processing station may automatically associate images of packaging of products with product information associated with the products without requiring a separate system or process for associating the images with the products.

As indicated above, FIG. 1 is provided as an example. Other examples may differ from what is described with regard to FIG. 1. The number and arrangement of devices shown in FIG. 1 are provided as an example. In practice, there may be additional devices, fewer devices, different devices, or differently arranged devices than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) shown in FIG. 1 may perform one or more functions described as being performed by another set of devices shown in FIG. 1.

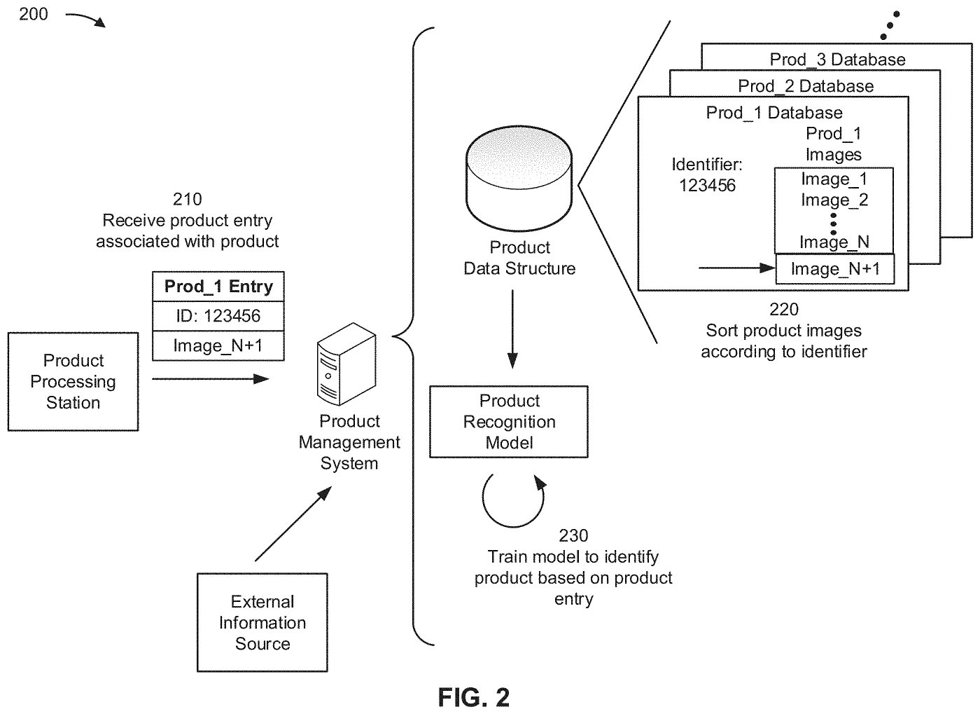

FIG. 2 is a diagram of an example implementation 200 associated with the product management system described herein. As shown in FIG. 2, example implementation 200 includes a product management system, a product processing station, and an external information source. These devices are described in more detail below in connection with FIG. 4 and FIG. 5.

The product management system, in example implementation 200, includes a product data structure that includes databases associated with a plurality of products (Prod_1 Database, Prod_2 Database, Prod_3 Database, . . . ). The product data structure may include, for one or more of the plurality of products, images associated with the one or more products. For example, as shown, for a product (Prod_1,) the product data base includes N images. The images may correspond to one or more images that were captured by an imager of the product processing station (which may correspond to the product processing station of example implementation 100) and/or another product processing station that is configured in a similar manner as the product processing station. Additionally, or alternatively, the images may correspond to one or more images that were provided by the external information source.

The external information source may include any suitable system or device that is configured to provide images that are associated with a product and/or packaging of a product. For example, the external information source may include an online marketplace (e.g., of a retailer, product manufacturer, or the like), a product blog, a news source associated with products, or the like. The product management system, as described herein, may receive product information and/or images associated with products via a Really Simple Syndication (RSS) or similar type of communication link. In this way, the product management system may store images associated with products within the product database to enable the product management system (and/or the product processing station) to detect, learn, and/or recognize packaging associated with a product, as described herein.

As shown in FIG. 2, and by reference number 210, the product management system receives a product entry, as described herein. As shown the product entry is associated with a product identified by an identifier (123456) and includes an image associated with the product (Image_N+1). For example, the product management system may receive the product entry based on the product processing station generating a product entry (e.g., based on the product being processed in association with a read of a barcode of the product). In some implementations, the product entry may be one of a plurality of product entries that are received in a batch from the product processing station (e.g., according to a batch processing technique associated with a batch of products that were processed by the product processing station).

As further shown in FIG. 2, and by reference number 220, the product management system sorts the product image according to an identifier of the product. For example, based on the product entry including an identifier of the product, the product management system may add the new image (Image_N+1) to the Prod_1 database. As shown in FIG. 2, the product data structure may include a plurality of images (Image_1 through Image_N) that were received prior to receiving the product entry. Accordingly, the newly received product entry can be added to the plurality of images and associated with the product identifier in the product data structure. In this way, the quantity of images that are received in connection with a particular identifier increases, thereby enabling the product recognition model to recognize or determine that a product (or packaging associated with a product) is associated with a particular identifier. Furthermore, after training the product recognition model as described elsewhere herein, the product recognition model may more accurately identify that an image that depicts a product (e.g., Prod_1) is associated with a particular product identifier (or product information).

As further shown in FIG. 2, and by reference number 230, the product management system trains the product recognition model to identify the product based on the product entry. For example, the product management system may train, as described herein, the product recognition model (or an image processing model of the product recognition model that is associated with Prod_1) to recognize packaging of the product as depicted in Image N+1. Accordingly, overtime, as the quantity of images that are received in connection with a particular identifier may increase, thereby enabling the product recognition model to recognize that a product (or packaging associated with a product) is associated with a particular identifier. Furthermore, after training the product recognition model, the more accurately the product recognition model is capable of learning or identifying that a product is associated with a particular product identifier (or product information).

As described herein, the product processing station and/or the product management system may utilize one or more image processing models to process an image that depicts a product, as described herein. For example, the product recognition model may use and/or include an image processing model (e.g., installed locally on the user device and/or on the barcode data management system) to detect and/or analyze packaging of products depicted in images captured by an imager (e.g., the imager of the product processing station). The image processing model may include and/or be associated with one or more machine learning models. For example, the image processing model may utilize a computer vision technique to assist in classifying image data as including or not including packaging associated with a product (e.g., a product associated with a barcode that is read by a barcode reader of the product processing station) as described herein.

In some cases, the image processing model may include a neural network (e.g., a convolutional neural network, a recurrent neural network, and/or the like) to implement the computer vision technique. The computer vision technique may include using an image recognition technique (e.g., an Inception framework, a ResNet framework, a Visual Geometry Group (VGG) framework, and/or the like) to recognize certain packaging of a product, an object detection technique (e.g., a Single Shot Detector (SSD) framework, a You Only Look Once (YOLO) framework, and/or the like) to detect the packaging, an edge detection technique to detect a bounding box associated with packaging of a product depicted in an image, an object in motion technique (e.g., an optical flow framework and/or the like) to analyze movement or rotation of the object based on the multiple images capturing various portions of the packaging, and/or the like.

An image processing model, as described herein, may be trained (e.g., by the product management system and/or the product processing station) using reference data that is associated with detecting and analyzing packaging associated with one or more products based on previously captured images associated with the one or more products and/or one or more parameters associated with the previously captured images. Such parameters may include one or more feature parameters associated with one or more features of the packaging (e.g., size, shape, color, or the like), one or more product processing station parameters associated with one or more configurations of the product processing station (e.g., a configuration of the barcode reader relative to the imager (or vice versa)), one or more barcode reader parameters (e.g., type, capability, or the like), one or more imager parameters associated with the imager (e.g., type, capability, location within the product processing station, or the like), one or more barcode parameters associated with read barcodes of the packaging (e.g., associated with appearances, such as shapes, sizes, types, and/or the like of various barcodes), and/or the like. Using the reference data and an image to the image processing model, the product processing station and/or the product management system, as described herein, may detect, learn, and/or recognize packaging associated with a product, as described herein.

In this way, the product processing station and/or the product management system may utilize a product entry that associates product information (obtained from a barcode read) with image data associated with the product to detect, learn, and/or recognize packaging associated with a product to permit the product processing station and/or the product management system.

As indicated above, FIG. 2 is provided as an example. Other examples may differ from what is described with regard to FIG. 2. The number and arrangement of devices shown in FIG. 2 are provided as an example. In practice, there may be additional devices, fewer devices, different devices, or differently arranged devices than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) shown in FIG. 2 may perform one or more functions described as being performed by another set of devices shown in FIG. 2.

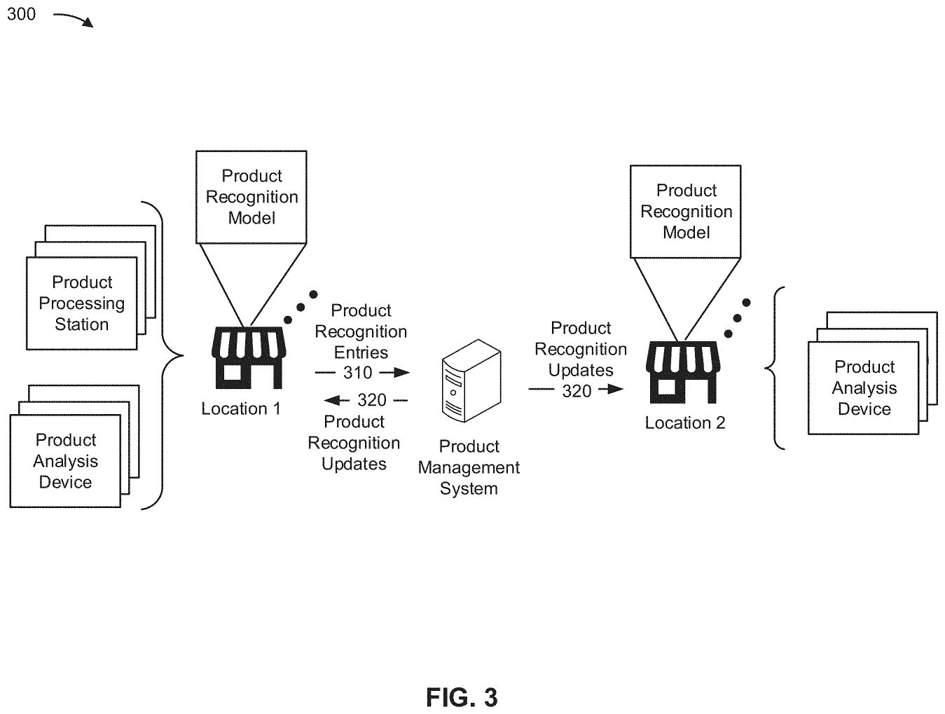

FIG. 3 is a diagram of an example implementation 300 associated with a product management system described herein. As shown in FIG. 3, example implementation 300 includes a product management system, a first location (Location 1) that includes a product recognition model and a second location (Location 2) that includes the product recognition model. The first location and the second location may correspond to branches (e.g., retail locations) associated with an entity.

As shown in FIG. 3, one or more product analysis devices may be included at the first location and at the second location. The product analysis devices may include any suitable device that utilizes the product recognition models at the locations. Furthermore, as shown, only the first location includes one or more product processing station configured, as described herein, while the second location may not.

As shown in FIG. 3, and by reference number 310, the product management system may receive product entries associated with products as described herein. As shown by reference number 320, the product management system may update the product recognition model at the first location and the second location according to the product entries, as described herein. In this way, the product management system may serve as a centralized location for collecting product entries and/or facilitate scaled retraining of product recognition models, as described herein.

As indicated above, FIG. 3 is provided as an example. Other examples may differ from what is described with regard to FIG. 3.

FIG. 4 is a diagram of an example environment 400 in which systems and/or methods described herein may be implemented. As shown in FIG. 4, environment 400 may include a product management system 410, one or more product processing stations 420, one or more product analysis devices 430, one or more external information sources 440, and a network 450. Devices of environment 400 may interconnect via wired connections, wireless connections, or a combination of wired and wireless connections.

The product management system 410 includes one or more devices capable of receiving, generating, storing, processing, providing, and/or routing information associated with a model and/or a data structure used to learn and/or recognize packaging associated with a product, as described elsewhere herein. The product management system 410 may include a communication device and/or a computing device. For example, the product management system 410 may include a server, such as an application server, a client server, a web server, a database server, a host server, a proxy server, a virtual server (e.g., executing on computing hardware), or a server in a cloud computing system. In some implementations, the product management system 410 includes computing hardware used in a cloud computing environment.

The product processing station 420 includes one or more devices capable of receiving, generating, storing, processing, and/or providing information associated with learning and/or recognizing packaging associated with a product, as described elsewhere herein. The product processing station 420 may include a communication device and/or a computing device. For example, the product processing station 420 may include a wireless communication device, a user device (e.g., a mobile phone, a user equipment, a laptop computer, a tablet computer, a desktop computer), an imager, a barcode reader, a RFID reader, a point-of-sale terminal, or a similar type of device.

The product analysis device 430 includes one or more devices capable of receiving, generating, storing, processing, and/or providing information associated with recognizing a product based on packaging of the product, as described elsewhere herein. The product analysis device 430 may include a communication device and/or a computing device. For example, the product analysis device 430 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), a camera (e.g., a security camera or other type of camera configured to recognize a product or track a product), or a similar type of device. In some implementations, the product analysis device 430 may include a robotic device (e.g., restocking device, a sorting device, a transport device, or other type of device) that is configured to manage or process a product as described herein.

The external information source 440 includes one or more devices capable of receiving, generating, storing, processing, and/or providing information associated with products, as described elsewhere herein. The external information source 440 may include a communication device and/or a computing device. For example, the external information source 440 may include a database, a server, a database server, an application server, a client server, a web server, a host server, a proxy server, a virtual server (e.g., executing on computing hardware), an online marketplace server, a server in a cloud computing system, a device that includes computing hardware used in a cloud computing environment, or a similar type of device. The external information source 440 may communicate with one or more other devices of environment 400, as described elsewhere herein.

The network 450 includes one or more wired and/or wireless networks. For example, the network 450 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 450 enables communication among the devices of environment 400.

The number and arrangement of devices and networks shown in FIG. 4 are provided as an example. In practice, there may be additional devices and/or networks, fewer devices and/or networks, different devices and/or networks, or differently arranged devices and/or networks than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) of environment 400 may perform one or more functions described as being performed by another set of devices of environment 400.

FIG. 5 is a diagram of example components of a device 500, which may correspond to the product management system 410, the product processing station 420, the product analysis device 430, and/or the external information sources 440. In some implementations, product management system 410, the product processing station 420, the product analysis device 430, and/or the external information sources include one or more devices 500 and/or one or more components of device 500. As shown in FIG. 5, device 500 may include a bus 510, a processor 520, a memory 530, an input component 540, an output component 550, and a communication component 560.

Bus 510 includes one or more components that enable wired and/or wireless communication among the components of device 500. Bus 510 may couple together two or more components of FIG. 5, such as via operative coupling, communicative coupling, electronic coupling, and/or electric coupling. Processor 520 includes a central processing unit, a graphics processing unit, a microprocessor, a controller, a microcontroller, a digital signal processor, a field-programmable gate array, an application-specific integrated circuit, and/or another type of processing component. Processor 520 is implemented in hardware, firmware, or a combination of hardware and software. In some implementations, processor 520 includes one or more processors capable of being programmed to perform one or more operations or processes described elsewhere herein.

Memory 530 includes volatile and/or nonvolatile memory. For example, memory 530 may include random access memory (RAM), read only memory (ROM), a hard disk drive, and/or another type of memory (e.g., a flash memory, a magnetic memory, and/or an optical memory). Memory 530 may include internal memory (e.g., RAM, ROM, or a hard disk drive) and/or removable memory (e.g., removable via a universal serial bus connection). Memory 530 may be a non-transitory computer-readable medium. Memory 530 stores information, instructions, and/or software (e.g., one or more software applications) related to the operation of device 500. In some implementations, memory 530 includes one or more memories that are coupled to one or more processors (e.g., processor 520), such as via bus 510.

Input component 540 enables device 500 to receive input, such as user input and/or sensed input. For example, input component 540 may include a touch screen, a keyboard, a keypad, a mouse, a button, a microphone, a switch, a sensor, a global positioning system sensor, an accelerometer, a gyroscope, and/or an actuator. Output component 550 enables device 500 to provide output, such as via a display, a speaker, and/or a light-emitting diode. Communication component 560 enables device 500 to communicate with other devices via a wired connection and/or a wireless connection. For example, communication component 560 may include a receiver, a transmitter, a transceiver, a modem, a network interface card, and/or an antenna.

Device 500 may perform one or more operations or processes described herein. For example, a non-transitory computer-readable medium (e.g., memory 530) may store a set of instructions (e.g., one or more instructions or code) for execution by processor 520. Processor 520 may execute the set of instructions to perform one or more operations or processes described herein. In some implementations, execution of the set of instructions, by one or more processors 520, causes the one or more processors 520 and/or the device 500 to perform one or more operations or processes described herein. In some implementations, hardwired circuitry is used instead of or in combination with the instructions to perform one or more operations or processes described herein. Additionally, or alternatively, processor 520 may be configured to perform one or more operations or processes described herein. Thus, implementations described herein are not limited to any specific combination of hardware circuitry and software.

The number and arrangement of components shown in FIG. 5 are provided as an example. Device 500 may include additional components, fewer components, different components, or differently arranged components than those shown in FIG. 5. Additionally, or alternatively, a set of components (e.g., one or more components) of device 500 may perform one or more functions described as being performed by another set of components of device 500.

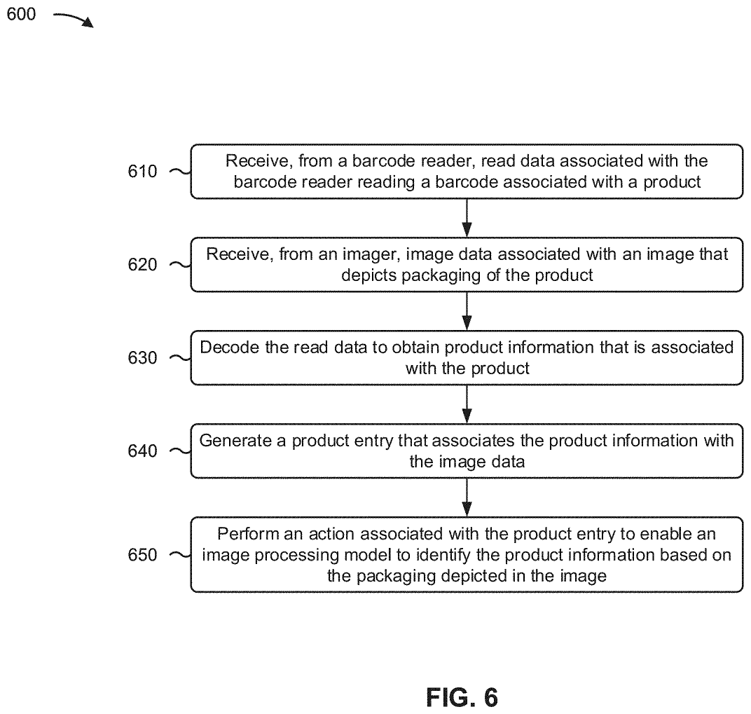

FIG. 6 is a flowchart of an example process 600 associated with a system configuration for learning and recognizing packaging associated with a product. In some implementations, one or more process blocks of FIG. 6 may be performed by a product processing station (e.g., the product processing station 420). In some implementations, one or more process blocks of FIG. 6 may be performed by another device or a group of devices separate from or including the product processing station, such as a product management system (e.g., the product management system 410) and/or a product analysis device (e.g., the product analysis device 430). Additionally, or alternatively, one or more process blocks of FIG. 6 may be performed by one or more components of device 500, such as processor 520, memory 530, input component 540, output component 550, and/or communication component 560.

As shown in FIG. 6, process 600 may include receiving, from a barcode reader, read data associated with the barcode reader reading a barcode associated with a product (block 610). For example, the product processing station may receive, from a barcode reader, read data associated with the barcode reader reading a barcode associated with a product, as described above.

As further shown in FIG. 6, process 600 may include receiving, from a camera, image data associated with an image that depicts packaging of the product (block 620). For example, the product processing station may receive, from a camera, image data associated with an image that depicts packaging of the product, as described above. The camera may capture the image in association with the barcode reader reading the barcode.

The product processing station may process the image data to identify a bounding box associated with a portion of the image that depicts the packaging. The image data may correspond to the content of the bounding box.

As further shown in FIG. 6, process 600 may include decoding the read data to obtain product information that is associated with the product (block 630). For example, the product processing station may decode the read data to obtain product information that is associated with the product, as described above. The product information may include a product identifier (e.g., a product name, an entity associated with the product information (e.g., a manufacturer of the product, a service provider associated with the product, a retailer associated with the product, or the like), a location of the product, and/or the like.

As further shown in FIG. 6, process 600 may include generating a product entry that associates the product information with the image data (block 640). For example, the product entry may associate a product identifier of a product with an image of the product, as described above.

The product entry may include configuration information associated with a configuration of the barcode reader and the camera. In some implementations, the device includes the barcode reader and the camera.

As further shown in FIG. 6, process 600 may include performing an action associated with the product entry to enable an image processing model to identify the product information based on the packaging depicted in the image (block 650). For example, the product processing station may perform an action associated with the product entry to enable an image processing model to identify the product information based on the packaging depicted in the image, as described above.

More specifically, the product processing station may transmit, to a product analysis system associated with the image processing model, the product entry to permit the product analysis system to train the image processing model based on the product entry. The product processing station may store the product entry in a reference data structure that includes reference data for training the image processing model.

In some implementations, the product processing station may train, based on the product entry, the image processing model to identify the product based on the packaging. The product processing station may be configured to use the trained image processing model to verify that individual barcodes that are attached to products are associated with the products based on an analysis of corresponding images of products that are obtained in association with the individual barcodes being read.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

The foregoing disclosure provides illustration and description, but is not intended to be exhaustive or to limit the implementations to the precise forms disclosed. Modifications and variations may be made in light of the above disclosure or may be acquired from practice of the implementations.

As used herein, the term “component” is intended to be broadly construed as hardware, firmware, and/or a combination of hardware and software. As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, or the like) on which machine-readable instructions (e.g., code in the form of, for example, software and/or firmware) can be stored. The instructions may be stored for any suitable duration of time, such as permanently, for an extended period of time (e.g., while a program associated with the instructions is executing), or for a short period of time (e.g., while the instructions are cached, during a buffering process, or the like). Further, as used herein, each of the terms “tangible machine-readable medium,” “non-transitory machine-readable medium” and “machine-readable storage device” is expressly defined to exclude propagating signals. That is, as used in any claim herein, a “tangible machine-readable medium,” a “non-transitory machine-readable medium,” and a “machine-readable storage device,” or the like, should not be interpreted as being implemented as a propagating signal.

As used herein, satisfying a threshold may, depending on the context, refer to a value being greater than the threshold, greater than or equal to the threshold, less than the threshold, less than or equal to the threshold, equal to the threshold, not equal to the threshold, or the like.

It will be apparent that systems and/or methods described herein may be implemented in different forms of hardware, firmware, or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method for enabling recognition of product packaging, comprising:
receiving, by a device and from a barcode reader, read data associated with the barcode reader reading a barcode associated with a product;
receiving, by the device and from an imager, image data associated with an image that depicts packaging of the product;
decoding, by the device, the read data to obtain product information that is associated with the product;
generating, by the device, a product entry that associates the product information with the image data; and
performing, by the device, an action associated with the product entry to enable an image processing model to identify the product information based on the packaging depicted in the image.

2. The method of claim 1, wherein the imager captured the image in association with the barcode reader reading the barcode.

3. The method of claim 1, further comprising:
processing the image to identify a bounding box associated with a portion of the image that depicts the packaging,
wherein the image data corresponds to content of the bounding box.

4. The method of claim 1, wherein performing the action comprises:
transmitting, to a product analysis system associated with the image processing model, the product entry to permit the product analysis system to train the image processing model based on the product entry.

5. The method of claim 1, wherein performing the action comprises:
storing the product entry in a reference data structure that includes reference data for training the image processing model.

6. The method of claim 1, wherein performing the action comprises:
training, based on the product entry, the image processing model to identify the product based on the packaging.

7. The method of claim 6, wherein the device is configured to use the trained image processing model to verify that individual barcodes that are attached to products are associated with the products.

8. The method of claim 1, wherein the device includes the barcode reader and the imager.

9. The method of claim 1, wherein the product entry includes configuration information associated with a configuration of the barcode reader and the imager.

10. A tangible machine-readable medium storing a set of instructions, the set of instructions comprising:
one or more instructions that, when executed by one or more processors of a device, cause the device to:
receive, from a barcode reader, read data associated with the barcode reader reading a barcode associated with a product;
receive, from an imager, image data associated with an image that depicts packaging of the product;
decode the read data to obtain product information that is associated with the product;
generate a product entry that associates the product information with the image data; and
perform an action associated with the product entry to enable an image processing model to identify the product information based on the packaging depicted in the image.

11. The tangible machine-readable medium of claim 10, wherein the imager captured the image in association with the barcode reader reading the barcode.

12. The tangible machine-readable medium of claim 10, wherein the one or more instructions further cause the device to:
process the image to identify a bounding box associated with a portion of the image that depicts the packaging,
wherein the image data corresponds to content of the bounding box.

13. The tangible machine-readable medium of claim 10, wherein the one or more instructions, that cause the device to perform the action, cause the device to:
transmit, to a product analysis system associated with the image processing model, the product entry to permit the product analysis system to train the image processing model based on the product entry.

14. The tangible machine-readable medium of claim 10, wherein the one or more instructions, that cause the device to perform the action, cause the device to:
store the product entry in a reference data structure that includes reference data for training the image processing model.

15. The tangible machine-readable medium of claim 10, wherein the one or more instructions, that cause the device to perform the action, cause the device to:
train, based on the product entry, the image processing model to identify the product based on the packaging.

16. The tangible machine-readable medium of claim 15, wherein the device is configured to use the trained image processing model to verify that individual barcodes that are attached to products are associated with the products.

17. The tangible machine-readable medium of claim 10, wherein the device includes the barcode reader and the imager.

18. A product processing station, comprising:
a barcode reader;
an imager;
one or more memories; and
one or more processors, communicatively coupled to the one or more memories, configured to:
receive, from the barcode reader, read data associated with a barcode that is associated with a product;
decode the read data to obtain product information that is associated with the product;
cause, based on receiving the read data from the barcode reader, the imager to capture an image that depicts packaging of the product;
generate an entry that associates the product information with image data associated with the image; and
perform an action associated with the entry to enable an image processing model to identify the product information based on the packaging depicted in the image.

19. The product processing station of claim 18, wherein a field of view of the imager and a field of view of the barcode reader include an overlapping portion that is within the field of view of the imager and the field of view of the barcode reader,
wherein the one or more processors are configured to cause the imager to capture the image when the product is in the overlapping portion.

20. The product processing station of claim 19, wherein the barcode reader is configured to read the barcode based on detecting the barcode within the overlapping portion.
